(19) United States
(12) Patent Application Publication
(10) Pub. No.: US 2018/0111137 A1
(43) Pub. Date: Apr. 26, 2018

(54) CLOSED LOOP CONTROL OF ELECTROSTATIC VOLTAGE AND CURRENT BASED ON HUMIDITY

(71) Applicants: Stephen Elliott, Denton, TX (US); Mark Menzie, Denton, TX (US); Austin Walker, Denton, TX (US)

(72) Inventors: Stephen Elliott, Denton, TX (US); Mark Menzie, Denton, TX (US); Austin Walker, Denton, TX (US)

(73) Assignee: PACCAR Inc, Bellevue, WA (US)

(21) Appl. No.: 15/792,438

(22) Filed: Oct. 24, 2017

Related U.S. Application Data
(60) Provisional application No. 62/411,819, filed on Oct. 24, 2016.

(51) Int. Cl. B05B 5/00; G01N 27/12; B05B 5/053

(52) U.S. Cl. CPC B05B 5/006; B05B 5/053; G01N 27/121

(57) ABSTRACT

A electrostatic spray system includes a sprayer that is configured to impart an electric charge on particles that are discharged from the sprayer. The system further includes a humidity sensor configured to sense humidity in a work area. An electrostatic controller is receives signals from the humidity sensor corresponding to the humidity in the work area. The electrostatic controller is programmed to selectively control the electrostatic charge imparted on the particles by the sprayer according to the signals received from the humidity sensor.

### CROSS-REFERENCE TO RELATED APPLICATION

This application claims the benefit of U.S. Provisional Patent Application No. 62/411,819, filed Oct. 24, 2016, which is incorporated herein by reference in its entirety.

### BACKGROUND

Applying paint to a workpiece using an electrostatic sprayer increases transfer efficiency between the paint applicator and the workpiece being painted. For a typical electrostatic sprayer application, atomized particles of paint are charged to a very high potential (nominally 80 thousand volts in relation to ground) and grounding the part being painted, charged particles of paint seeking the grounded surface and thereby completing the circuit which consists of ground system, power converter, high voltage generator, paint applicator, gaseous environment (that exists between applicator and part), and the part being painted, current flowing from applicator to the part which is electrically connected to ground, thereby completing the circuit through which current flows. Paint is compelled by the electric charge to flow from applicator to part, maximizing the amount of paint that lands on the part and minimizing the amount that is wasted as overspray. In this way, electrostatic painting has major advantages relative to both coverage and waste minimization.

However, use of electro-static painting comes with multiple challenges, including (1) safety, including fire prevention, (2) downtime associated with fault conditions (momentary excessive current conditions) that stop the application process to mitigate fire risk, where fire could occur in the presence of an arc, and (3) variation in transfer efficiency with variation in electrostatic current as a function of the environment, specifically humidity, which has the potential to manifest in many different defect forms depending on whether humidity is relatively higher or relatively lower than that which is optimal.

### SUMMARY

A first representative embodiment of a spray system according to the present disclosure includes a sprayer that is configured to impart an electric charge on particles that are discharged from the sprayer. The system further includes a humidity sensor configured to sense humidity in a work area. An electrostatic controller is receives signals from the humidity sensor corresponding to the humidity in the work area. The electrostatic controller is programmed to selectively control the electrostatic charge imparted on the particles by the sprayer according to the signals received from the humidity sensor

A second representative embodiment of a spray system according to the present disclosure includes a sprayer configured to provide an electric charge to particles discharged from the sprayer such that the charge creates a current through the spray system. The spray system further includes current sensor configured to sense the current. An electrostatic controller is operably coupled to the sprayer and to the current sensor. The electrostatic controller receives signals from the current sensor and is programmed to control the sprayer to maintain a constant current in the system.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows a first representative embodiment of an electrostatic paint system according to the presently disclosure; and

FIG. 2 shows a second representative embodiment of an electrostatic paint system according to the presently disclosure.

### DETAILED DESCRIPTION

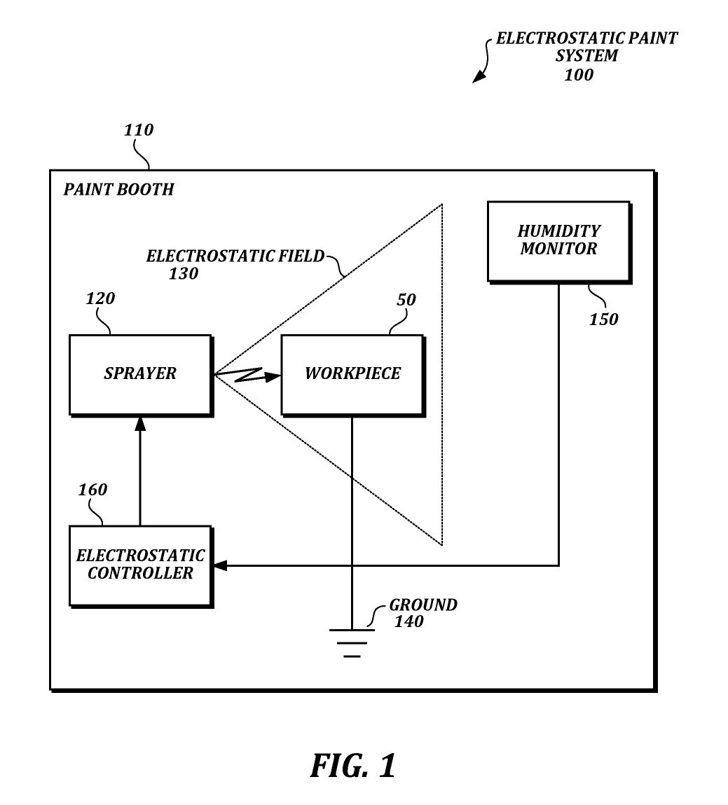

A first representative embodiment of an electrostatic paint system 100 is shown in FIG. 1. The system 100 includes a paint booth 110 within which paint or any other suitable coating is applied to a workpiece 50. The paint booth 110 provides a workspace in which contamination and environmental conditions can be controlled. The disclosed paint booth 100 can include cross-flow, side downdraft, or any other known filtration utilized in paint booths. In this regard, the disclosed system 110 is not limited to use with any particular paint booth and can include any known paint booth or other suitable contamination control booth.

A workpiece 50 to be coated is positioned within the paint booth 110. The workpiece 50 has an electrically conductive surface that is grounded through a ground 140. A known electrostatic sprayer 120 is positioned within the booth proximate to the workpiece 50. The sprayer 120 emits a spray of atomized paint particles that are charged to a high potential. The charged paint particles produce an electrostatic field 130 around the workpiece 50 and are drawn to the grounded surface of the workpiece.

An electrostatic controller 160 is operatively associated with the sprayer 120 and selectively controls the electrostatic charge imparted on the paint particles by the sprayer. The electrostatic controller 160 is also operatively associated with a humidity monitor 150. The humidity monitor 150 is a known sensor that senses the humidity within the paint booth 110 and sends signals corresponding to the sensed humidity to the electrostatic controller 160. It will be appreciated that the humidity monitor 150 can be any known sensor to directly sense the humidity. Alternatively, the humidity monitor 150 can sense other environmental conditions to indirectly determine the humidity. In will be appreciated that the disclosed embodiment is not limited to any particular humidity sensor, but can utilize any system or method of determining the humidity within or affecting the paint booth 110.

The electrostatic controller 160 receives signals from the humidity monitor 150 and controls the charge imparted by the electrostatic sprayer 120 on the paint particles accordingly. More specifically, when an increase in humidity is sensed, the electrostatic controller 160 decreases the charge imparted by the electrostatic sprayer 120.

Conversely, when a decrease in humidity is sensed, the electrostatic controller 160 increases the charge imparted by the electrostatic sprayer 120.

It is believed that the electrostatic field effect increases with the humidity inside the paint booth 110, making paint transfer more efficient, this being due to an increase in the conductivity of air as a function of humidity. Consequently, an increase in humidity, such as during rainy weather or during high humidity environmental fault conditions, can result in excess paint being applied to the workpiece, as well as other operational variations. In the disclosed system 100, the electrostatic controller 160 employs humidity data from humidity monitor 150 algorithmically to determine output voltage with the goal of maintaining a consistent current required for optimal transfer efficiency and defect minimization regardless of external climate and the resultant impact on internal environment. By controlling the electrostatic charge according to humidity, the electrostatic paint system 100 provides the following advantages:
A. Allows for a more stable and consistent application environment with increased immunity to environmental conditions, specifically humidity, by automatically adapting to the changing application environment, thereby providing consistent electrostatic effect and transfer efficiency and self-correcting for variations in humidity thereby resulting in reduced humidity related process variation which may result if the environment is either too humid or too dry which has the potential to result in paint finish defects including solvent pop, orange peel, runs, sags, excessive film build, light paint, thin paint, inconsistent coverage, and mottling, AND attraction of water (H2O) out of the air and onto the surface where it can interfere with rheology and cure.
B. Reduces the potential for excessive current conditions when humidity rises and so doing, provides for a safer application environment, with reduced potential for arcing and associated fire risk;
C. Reduces the frequency of electrostatic faults due to excessive current, which again rise in frequency with increased humidity conditions, thereby reducing alarms and associated downtime related to faults;
D. Prevents the attraction of water out of the air and onto the part, which, depending on paint chemistry can result in various defects and process anomalies including outgassing and variations in cure rate/completeness; and
E. May reduce the dependence on aggressive control of plant environment, specifically humidity, which depending on external conditions may require large scale high volume dehumidification of incoming air, typically employing chilled water and heat to de-humidify, and steam to humidify, both of which can require large energy expenditure with associated environmental impact.

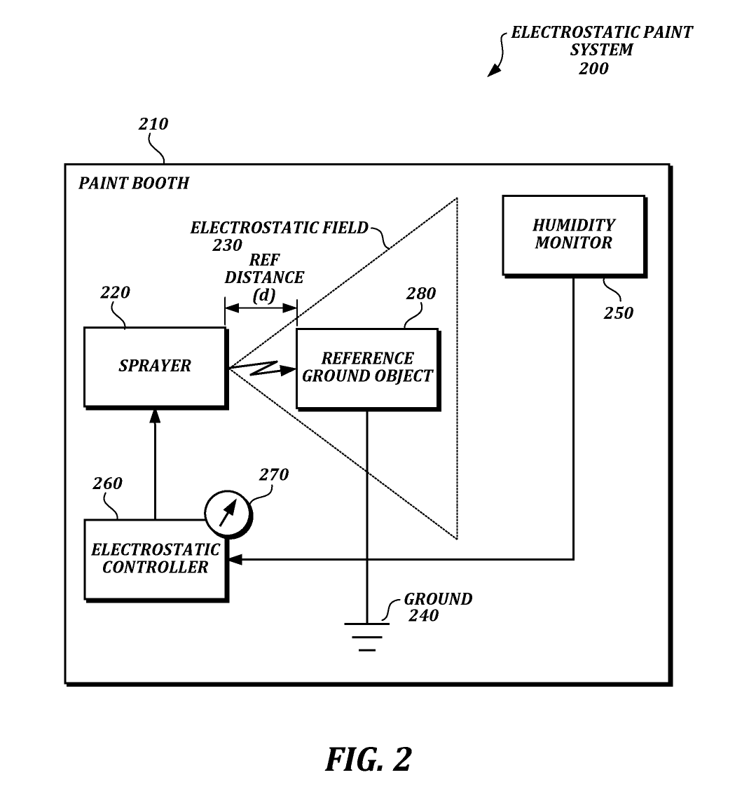

A second representative embodiment of an electrostatic paint system 200 is shown in FIG. 2. Except as noted below, the electrostatic paint system 200 of FIG. 2 is similar to the system 100 of FIG. 1, wherein a part having reference number 2XX in FIG. 2 corresponds to a similar part having a reference number 1XX in FIG. 2.

As shown in FIG. 2, the electrostatic controller 260 is configured to determine or sense the current of the system with a current sensor 270. It will be appreciated that the current sensor 270 need not be integral with the electrostatic controller 260, as illustrated, but can be a separate sensor that sends signals indicating the current to the controller 260. Further, the current may be directly measured or calculated based on other system variables.

The system 200 of FIG. 2 calibrates the electrostatic parameters to align optimally with present state internal application environmental conditions, particularly humidity which is a function of water content of the air. More specifically, the electrostatic paint gun 220 is registered on a reference grounded object, at a reference distance, and assessing present state current—current being a function of voltage applied and the conductivity of the air as a function of present humidity. Based on assessment of current, the electrostatic controller 260 sets the voltage to facilitate a desired current for optimal transfer and paint application quality.

In one representative embodiment, the voltage may be ramped from 0 to 100,000 volts, for example in 5,000 volt increments, and the current assessed at each moment, yielding comprehensive knowledge of the voltage vs. current relationship that exists in the application environment. The electrostatic controller 220 may then provide the voltage that yields the desired optimal current.

Similarly, the distance d between the electrostatic paint gun 220 and the reference ground object 280 may be varied across the reference range to sense distance related parametric changes. During robotic painting operation, it is desirable that the sprayer maintain a consistent distance from the workpiece, nominally 1 inch per 10,000 volts, this to reduce the potential for arcing and risk of fire, however, in practice this is not always possible—sometimes in order to apply paint to certain aspects of a workpiece, the distance between sprayer and piece must be increased or decreased. Consequently, prior knowledge of how current increases and decreases with proximity between sprayer 120 and workpiece 50 can be taken into account by the electrostatic controller to in order to maintain a constant current during painting operation.

The calibration of electrostatic parameters with the application environment may be performed with human intervention or autonomously by the electrostatic controller 220. The frequency of calibration is a function of external weather conditions and internal environmental control. The disclosed embodiment allows for the frequency of the calibration interval to be programmable.

Advantages provided by the system 200 of FIG. 2 include:
A. Automatically accounts for variations in application environment as a function of changing external weather or internal environmental situation;
B. Automated calibration has the potential to reduce dependency on aggressive and energy intensive environmental control to account for rapidly changing external or internal conditions; and
C. Capability to assess effective application environment conductivity without reliance on external humidity sensing.

While the preferred embodiment of the invention has been illustrated and described, it will be appreciated that various changes can be made therein without departing from the spirit and scope of the invention.

1. A spray system, comprising:
a sprayer configured to impart an electric charge on particles discharged from the sprayer;
a humidity sensor configured to sense a humidity in a work area; and
an electrostatic controller operably coupled to the sprayer and to the humidity sensor, wherein the electrostatic controller receives signals from the humidity sensor corresponding to the humidity in the work area, and the electrostatic controller is programmed to selectively control the electrostatic charge imparted on the particles according to the signals received from the humidity sensor.

2. The spray system of claim 1, wherein the particles comprise paint.

3. The spray system of claim 2, wherein the work area is a paint booth.

4. The spray system of claim 1, wherein the workpiece is electrically grounded.

5. The spray system of claim 1, wherein the electrostatic controller is programmed to increase the electric charge imparted on the particles in response to a sensed decrease in humidity in the work area.

6. The spray system of claim 5, wherein the electrostatic controller is programmed to decrease the electric charge imparted on the particles in response to a sensed increase in humidity in the work area.

7. The spray system of claim 1, wherein the electrostatic controller is programmed to decrease the electric charge imparted on the particles in response to a sensed increase in humidity in the work area.

8. A spray system, comprising:
a sprayer configured to provide an electric charge to particles discharged from the sprayer, the charge creating a current through the spray system;
a current sensor configured to sense the current; and
an electrostatic controller operably coupled to the sprayer and to the current sensor, wherein the electrostatic controller receives signals from the current sensor and is programmed to control the sprayer to maintain a constant current in the system.

9. The spray system of claim 8, wherein the particles comprise paint.

10. The spray system of claim 9, wherein the work area is a paint booth.

11. The spray system of claim 8, wherein the workpiece is electrically grounded.

12. The spray system of claim 8, wherein the electrostatic controller is programmed to increase the electric charge imparted on the particles in response to a sensed decrease in humidity in the work area.

13. The spray system of claim 12, wherein the electrostatic controller is programmed to decrease the electric charge imparted on the particles in response to a sensed increase in humidity in the work area.

14. The spray system of claim 8, wherein the electrostatic controller is programmed to decrease the electric charge imparted on the particles in response to a sensed increase in humidity in the work area
